(19) United States
(12) Patent Application Publication
(10) Pub. No.: US 2017/0220196 A1
(43) Pub. Date: Aug. 3, 2017

(54) POSITION DETECTION DEVICE, POSITION DETECTION SYSTEM, AND, POSITION DETECTION METHOD

(71) Applicant: SEIKO EPSON CORPORATION, Tokyo (JP)

(72) Inventors: Babak MOUSSAKHANI, Trondheim (NO); Kenji TANAKA, Trondheim (NO)

(73) Assignee: SEIKO EPSON CORPORATION, Tokyo (JP)

(21) Appl. No.: 15/392,464

(22) Filed: Dec. 28, 2016

(30) Foreign Application Priority Data
Feb. 3, 2016 (JP) 2016-018863

(51) Int. Cl. G06F 3/041; G06F 3/042

(52) U.S. Cl. CPC G06F 3/0418; G06F 3/0425

(57) ABSTRACT

A position detection device includes an imaging unit that captures an image of light emitted by the spontaneous emission pointing element on the operation surface and generates a captured image; a detection unit that detects the pointing position based on the spontaneous emission pointing element on the basis of the captured image; and a correction unit that corrects the pointing position, using a correction value determined in accordance with a tip offset which is a distance between a contact position at which the spontaneous emission pointing element comes into contact with the operation surface and an emission position of the spontaneous emission pointing element. The correction unit corrects the pointing position using a correction value varying according to a position on the operation surface.

The entire disclosure of Japanese Patent Application No. 2016-018863, filed Feb. 3, 2016 is expressly incorporated by reference herein.

### BACKGROUND

1. Technical Field

The present invention relates to a position detection device capable of detecting the pointing position of a pointing element on an operation surface.

2. Related Art

JP-A-2015-158887 and JP-A-2015-158890 disclose interactive projectors having a function as a position detection device. These interactive projectors project a projected screen onto a screen, and capture an image including a pointing element such as a luminous pen or a finger through a camera, thereby allowing the position of the pointing element to be detected using this captured image. That is, the interactive projector recognizes that predetermined pointing such drawing is input to a projected screen when the tip of the pointing element is in contact with a screen, and redraws the projected screen in accordance with the pointing. Therefore, a user can input various types of pointing, using the projected screen as a user interface.

In JP-A-2015-158887 and JP-A-2015-158890, a light irradiation device (“also called a light curtain unit”) is used which emits curtain-shaped (or layered) detection light onto the surface of a screen in order to detect the pointing element. In a case where the detection light is reflected by the pointing element when the pointing element is brought into contact with the screen, an image of the position of the reflected light is captured by a camera, and thus the position of the pointing element on the projected screen can be determined by analyzing the captured image.

The curtain-shaped detection light is present at a position slightly away from the screen surface. Therefore, in a case where a finger (non-emission pointing element) is used as the pointing element, a position to which the detection light is reflected by a finger is located at a position slightly away from the screen surface. Therefore, in a case where the captured image including this reflected light is analyzed by a camera and the pointing position of the pointing element is determined, a position including an error caused by a distance between the reflection position of the detection light by a finger and the screen surface is obtained. JP-A-2015-158890 discloses a technique for correcting the pointing position using a distance between the screen surface and the reflection position to which the detection light is reflected by a finger in order to eliminate such an error.

JP-A-2015-158890 discloses that the correction as described above is not required in a case where a luminous pen is used as the pointing element, and that the position of an image of light emitted by the luminous pen can be regarded as the pointing position of the luminous pen.

However, the inventor has found that, even in a case where a spontaneous emission pointing element such as a luminous pen is used, a nonzero distance (called the “tip offset”) is present between the emission position of the spontaneous emission pointing element and the screen surface (also called the “operation surface”), and a detection error may occur in the pointing position of the spontaneous emission pointing element due to this tip offset. In addition, it can be understood that, while the physical emission position of the spontaneous emission pointing element does not change, the tip offset which is obtained by the analysis of the captured image is not constant, and changes depending on the position of the screen surface. The reason for the tip offset obtained by the image analysis not being constant is because an error occurs in the emission position due to the influence of the reflected light from the screen or the influence of the size of light visible from a camera.

The aforementioned problem is a problem which is generally common to position detection devices that detect a pointing position pointed by the spontaneous emission pointing element on the operation surface, without being limited to an interactive projector that detects the pointing position of the spontaneous emission pointing element using a camera and a light curtain unit.

### SUMMARY

An advantage of some aspects of the invention is to solve at least a part of the problems described above, and the invention can be implemented as the following forms or application examples.

(1) An aspect of the invention provides a position detection device that detects a pointing position pointed by a spontaneous emission pointing element on an operation surface. The position detection device includes: an imaging unit that captures an image of light emitted by the spontaneous emission pointing element on the operation surface and generates a captured image; a detection unit that detects the pointing position based on the spontaneous emission pointing element on the basis of the captured image; and a correction unit that corrects the pointing position, using a correction value determined in accordance with a tip offset which is a distance between a contact position at which the spontaneous emission pointing element comes into contact with the operation surface and an emission position of the spontaneous emission pointing element. The correction unit corrects the pointing position using a correction value varying according to a position on the operation surface.

According to the position detection device, the pointing position of the spontaneous emission pointing element is corrected using the correction value determined in accordance with the tip offset. In this case, since the correction value varying according to the position on the operation surface is used, the pointing position can be corrected using an appropriate correction value according to the position on the operation surface. As a result, it is possible to reduce the detection error of the pointing position occurring due to the tip offset.

(2) In the position detection device, the correction unit may correct the pointing position using a correction value varying according to the position on the operation surface and a distance from the imaging unit to the operation surface.

According to such a configuration, since the correction value has a value varying according to not only the position on the operation surface, but also the distance from the imaging unit to the operation surface, it is possible to correct the pointing position using a more appropriate correction value, and to further reduce the detection error of the pointing position occurring due to the tip offset.

(3) In the position detection device, the correction unit may determine the correction value using a function in which coordinates on the operation surface and the distance from the imaging unit to the operation surface are used as variables.

According to such a configuration, it is possible to easily determine the correction value using a function in which the coordinates on the operation surface and the distance from the imaging unit to the operation surface are used as variables.

(4) In the position detection device, the function may be a function to which the tip offset is given using the coordinates on the operation surface and the distance from the imaging unit to the operation surface as variables.

According to such a configuration, it is possible to obtain the tip offset using a function in which the coordinates on the operation surface and the distance from the imaging unit to the operation surface are used as variables, and to determine the correction value in accordance with this tip offset.

(5) The position detection device may further include a projection unit that projects an image onto the operation surface.

According to such a configuration, it is possible to project an appropriate image according to the pointing position of the spontaneous emission pointing element onto the operation surface.

The invention can be realize in various aspects, and can be realized in various aspects such as, for example, a position detection device, a position detection system including a spontaneous emission pointing element and the position detection device, a position detection method, a computer program for realizing functions of the method or the device, and a non-transitory storage medium having the computer program recorded thereon.

### BRIEF DESCRIPTION OF THE DRAWINGS

The invention will be described with reference to the accompanying drawings, wherein like numbers reference like elements.

FIG. 1 is a perspective view of a position detection system.

FIG. 2A is a front view of the position detection system.

FIG. 2B is a side view of the position detection system.

FIG. 3 is a block diagram illustrating an internal configuration of a projector.

FIG. 4 is a diagram illustrating a detection error of the pointing position of a spontaneous emission pointing element.

FIG. 5 is a diagram illustrating a distribution example of a tip offset.

FIG. 6 is a diagram illustrating a detection error of a pointing position according to the tip offset and a correction method thereof.

### DESCRIPTION OF EXEMPLARY EMBODIMENTS

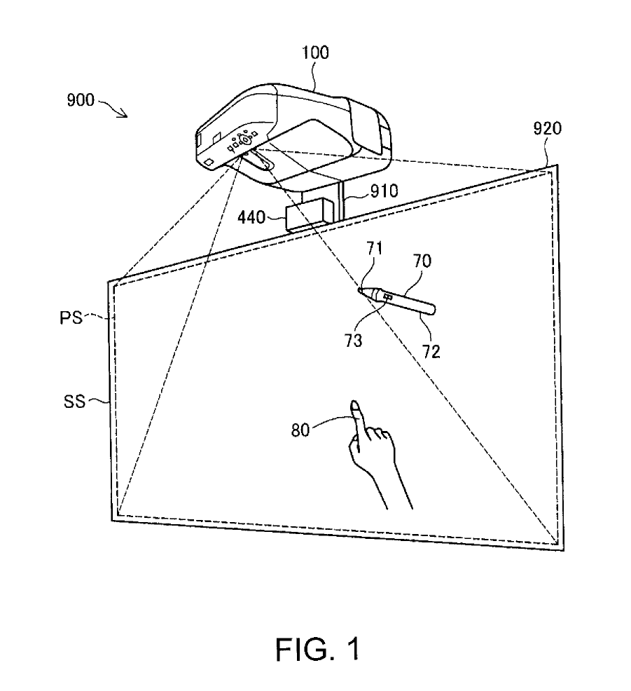

FIG. 1 is a perspective view of a position detection system 900 as an embodiment of the invention. This system 900 includes an interactive projector 100 as a position detection device, a screen plate 920 which is provided with an operation surface, a layered detection light irradiation unit 440 (light curtain unit), and a spontaneous emission pointing element 70. The layered detection light irradiation unit 440 is a portion of the interactive projector 100, but is depicted separately from the interactive projector, for convenience of illustration, in FIG. 1. The foreside of the screen plate 920 is used as a projection screen surface SS. The projector 100 is fixed to the front and upper side of the screen plate 920 by a support member 910. In FIG. 1, the projection screen surface SS is vertically disposed, but the projection screen surface SS is horizontally disposed, and thus this system 900 can also be used.

The projector 100 projects a projected screen PS onto the projection screen surface SS. The projected screen PS normally includes an image drawn within the projector 100. In a case where an image drawn within the projector 100 is not present, the projected screen PS is irradiated with light from the projector 100, a white image is displayed. In the present specification, the “projection screen surface SS” means the surface of a member onto which an image is projected. In addition, the “projected screen PS” means a region of an image which is projected onto the screen surface SS by the projector 100. Normally, the projected screen PS is projected onto a portion of the projection screen surface SS. The projection screen surface SS is also used as an operation surface for performing position pointing based on a pointing element, and thus is also called an “operation surface SS”.

The spontaneous emission pointing element 70 is a pen-type pointing element including a tip portion 71 capable of emitting light, a shank 72 which is held by a user, and a button switch 73 provided on the shank 72. The tip portion 71 of the spontaneous emission pointing element 70 emits, for example, infrared light. The configuration or function of the spontaneous emission pointing element 70 will be described later. In this system 900, one or a plurality of non-emission pointing elements 80 (such as a non-emission pen or a finger) can be used together with one or a plurality of spontaneous emission pointing elements 70.

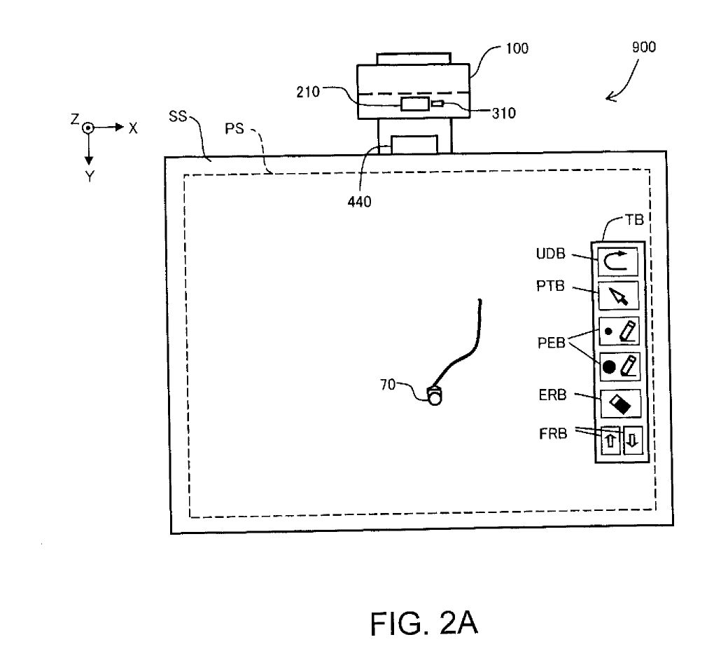

FIG. 2A is a front view of the position detection system 900, and FIG. 2B is a side view thereof. In the present specification, a direction along the right and left of the operation surface SS is defined as an X-direction, a direction along the top and bottom of the operation surface SS is defined as a Y-direction, and a direction along the normal line of the operation surface SS is defined as a Z-direction. In addition, the upper left position of the operation surface SS in FIG. 2A is set to the origin (0, 0) of coordinates (X, Y). For convenience, the X-direction is also called a “horizontal direction”, the Y-direction is also called a “vertical direction”, and the Z-direction is also called a “front/rear direction”. In addition, a direction in which the projected screen PS is present in the Y-direction (vertical direction) when seen from the projector 100 is called a “downward direction”. In FIG. 2B, for convenience of illustration, a range of the projected screen PS in the screen plate 920 is hatched.

The projector 100 includes a projection lens 210 that projects the projected screen PS onto the operation surface SS, a camera 310 that captures an image of a region of the projected screen PS, and a layered detection light irradiation unit 440 for irradiating pointing elements (spontaneous emission pointing element 70 and non-emission pointing element 80) with layered detection light LL (FIG. 2B). the layered detection light irradiation unit 440 is an irradiation unit that emits the layered (or curtain-shaped) detection light LL over the entire surface of the projected screen PS in order to detect that the non-emission pointing element 80 is in contact with the projected screen PS (that is, operation surface SS). As the layered detection light LL, for example, infrared light can be used. Here, the term “layered” or “curtain-shaped” means a space shape having a substantially uniform small thickness. A distance between the operation surface SS and the layered detection light LL is set to, for example, a value of a range of 1 to 10 mm (preferably, 1 to 5 mm).

The camera 310 has at least a first imaging function of receiving and imaging the layered detection light LL (infrared light) and light of a wavelength region including the wavelength of infrared light which is emitted by the spontaneous emission pointing element 70. It is preferable that the camera 310 further has a second imaging function of receiving and imaging light including visible light, and is configured to be capable of switching these two imaging functions. For example, it preferable that the camera 310 includes a near-infrared filter switching mechanism (not shown) capable of disposing a near-infrared filter that blocks visible light to allow passage of only near-infrared light in front of a lens or retreating the filter from the front of the lens. As shown in FIG. 2B, the camera 310 is installed at a position a distance L away from the operation surface SS in the Z-direction.

The example of FIG. 2A shows a status where the position detection system 900 operates in a whiteboard mode. The whiteboard mode is a mode in which a user can arbitrarily draw an image onto the projected screen PS using the spontaneous emission pointing element 70 or the non-emission pointing element 80. The projected screen PS including a tool box TB is projected onto the operation surface SS. This tool box TB includes a cancel button UDB for restoring a process, a pointer button PTB for selecting a mouse pointer, a pen button PEB for selecting a pen tool for drawing, an eraser button ERB for selecting an eraser tool that erases a drawn image, and front/rear buttons FRB for advancing a screen next or returning a screen back. A user clicks these buttons using a pointing element, and thus can perform processes according to the buttons, or select a tool. Immediately after the startup of the system 900, a mouse pointer may be selected as a default tool. In the example of FIG. 2A, a user selects a pen tool, and then moves the tip portion 71 of the spontaneous emission pointing element 70 into the projected screen PS in a state of being brought into contact with the operation surface SS. Thereby, a status where a line is drawn into the projected screen PS is depicted. This line is drawn by a projection image generation unit (described later) located inside the projector 100.

The position detection system 900 can operate in modes other than the whiteboard mode. For example, this system 900 can also operate in a PC interactive mode in which an image of data transmitted from a personal computer (not shown) through a communication line is displayed on the projected screen PS. In the PC interactive mode, an image of data such as, for example, spreadsheet software is displayed, and data can be input, created, corrected, and the like using various tools or icons displayed within the image.

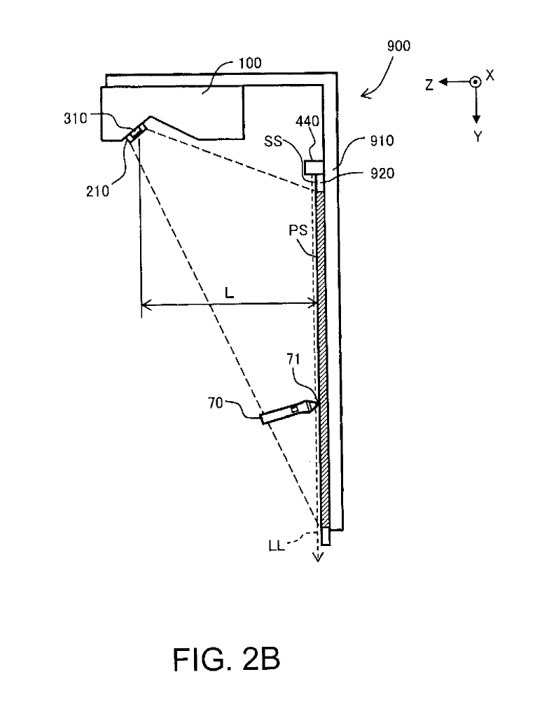

FIG. 3 is a block diagram illustrating internal configurations of the interactive projector 100 and the spontaneous emission pointing element 70. The projector 100 includes a control unit 700, a projection unit 200, a projection image generation unit 500, a position detection unit 600, an imaging unit 300, a signal light transmitting unit 430, and a layered detection light irradiation unit 440.

The control unit 700 controls each unit located inside the projector 100. In addition, the control unit 700 determines the contents of pointing performed on the projected screen PS in accordance with the pointing position of a pointing element (spontaneous emission pointing element 70 or non-emission pointing element 80) detected by the position detection unit 600, and commands the projection image generation unit 500 to create or change a projection image in accordance with the contents of the pointing.

The projection image generation unit 500 includes a projection image memory 510 that has a projection image stored therein, and has a function of generating a projection image which is projected into the operation surface SS by the projection unit 200. It is preferable that the projection image generation unit 500 further has a function as a keystone correction unit that corrects trapezoidal distortion of the projected screen PS (FIG. 2A).

The projection unit 200 has a function of projecting the projection image generated by the projection image generation unit 500 into the operation surface SS. The projection unit 200 includes an optical modulation unit 220 and a light source 230 in addition to the projection lens 210 described in FIG. 2B. The optical modulation unit 220 forms projection image light IML by modulating light from the light source 230 in accordance with projection image data which is supplied from the projection image memory 510. This projection image light IML is color image light typically including visible light of three colors of RGB, and is projected onto the operation surface SS by the projection lens 210. As the light source 230, various light sources such as a light-emitting diode or a laser diode can be adopted in addition to a light source lamp such as an ultra-high pressure mercury lamp. In addition, the optical modulation unit 220 can have a light-transmissive or reflection-type liquid crystal panel digital mirror device or the like adopted therein, and may be configured to include a plurality of optical modulation units 220 for each colored light.

The signal light transmitting unit 430 has a function of transmitting device signal light ASL which is received by the spontaneous emission pointing element 70. The device signal light ASL is a synchronizing near-infrared light signal, and is periodically emitted from the signal light transmitting unit 430 of the projector 100 to the spontaneous emission pointing element 70. A tip light-emitting unit 77 of the spontaneous emission pointing element 70 emits pointing element signal light PSL (described later) which is near-infrared light having a predetermined light-emitting pattern (light emission sequence) in synchronization with the device signal light ASL. In addition, the camera 310 of the imaging unit 300 executes image capture at a predetermined timing synchronized with the device signal light ASL when the positions of pointing elements (spontaneous emission pointing element 70 and non-emission pointing element 80) are detected.

The imaging unit 300 includes the camera 310 described in FIGS. 2A and 2B. As described above, this camera 310 has a function of receiving and imaging the layered detection light LL and light of a wavelength region including the wavelength of infrared light which is emitted by the spontaneous emission pointing element 70. In the example of FIG. 3, a status is depicted in which the layered detection light LL emitted by the layered detection light irradiation unit 440 is reflected from the pointing elements (spontaneous emission pointing element 70 and non-emission pointing element 80), and the reflection detection light RDL is received and imaged by the camera 310. The camera 310 further receives and images the pointing element signal light PSL which is near-infrared light emitted from the tip light-emitting unit 77 of the spontaneous emission pointing element 70. The image capture of the camera 310 is executed in both a first period in which the layered detection light LL emitted from the layered detection light irradiation unit 440 is in an on-state (emission state), and a second period in which the layered detection light LL is in an off-state (non-emission state). The position detection unit 600 compares images in these two types of period with each other, and thus can determine whether an individual pointing element included in the images is the spontaneous emission pointing element 70 or the non-emission pointing element 80.

The position detection unit 600 has a function of analyzing an image captured by the camera 310 and determining the pointing position of the pointing element (spontaneous emission pointing element 70 or non-emission pointing element 80). In this case, the position detection unit 600 also determines whether an individual pointing element within the image is the spontaneous emission pointing element 70 or the non-emission pointing element 80, using the light-emitting pattern of the spontaneous emission pointing element 70. In the present embodiment, the position detection unit 600 includes a detection unit 610, a correction unit 620, and a correction data memory 630. The detection unit 610 has a function of analyzing the captured image captured by the camera 310 and detecting the pointing position of the pointing element. The correction unit 620 has a function of correcting the pointing position detected by the detection unit 610. The correction data memory 630 is a non-volatile memory for storing correction data which is used for correction by the correction unit 620.

The detection unit 610 and the correction unit 620 have a function of the detecting and correcting the pointing positions with respect to both the spontaneous emission pointing element 70 and the non-emission pointing element 80, but hereinafter, a function of detecting and correcting the pointing position targeted at the spontaneous emission pointing element 70 will be mainly described. The correction unit 620 has a function of correcting the pointing position detected by the detection unit 610, using a correction value determined in accordance with a tip offset which is a distance between a contact position at which the spontaneous emission pointing element 70 comes into contact with the operation surface SS and the emission position of the spontaneous emission pointing element 70. This function will be further described later.

The spontaneous emission pointing element 70 is provided with a signal light receiving unit 74, a control unit 75, a tip switch 76, and the tip light-emitting unit 77, in addition to the button switch 73. The signal light receiving unit 74 has a function of receiving the device signal light ASL emitted from the signal light transmitting unit 430 of the projector 100. The tip switch 76 is a switch which is set to be in an on-state when the tip portion 71 of the spontaneous emission pointing element 70 is pressed, and is set to be in an off-state when the tip portion 71 is released. The tip switch 76 is normally set to be in an off-state, and is set to be in an on-state due to contact pressure when the tip portion 71 of the spontaneous emission pointing element 70 comes into contact with the operation surface SS. When the tip switch 76 is in an off-state, the control unit 75 causes the tip light-emitting unit 77 to emit light in a first specific light-emitting pattern indicating that the tip switch 76 is in an off-state, and thus emits the pointing element signal light PSL having the first light-emitting pattern. On the other hand, when the tip switch 76 is set to be in an on-state, the control unit 75 causes the tip light-emitting unit 77 to emit light in a second specific light-emitting pattern indicating that the tip switch 76 is in an on-state, and thus emits the pointing element signal light PSL having the second light-emitting pattern. Since the first light-emitting pattern and the second light-emitting pattern are different from each other, the position detection unit 600 can identify that the tip switch 76 is in an on-state or an off-state by analyzing the image captured by the camera 310.

The button switch 73 of the spontaneous emission pointing element 70 has the same function as that of the tip switch 76. Therefore, the control unit 75 causes the tip light-emitting unit 77 to emit light in the second light-emitting pattern in a state where the button switch 73 is pressed by a user, and causes the tip light-emitting unit 77 to emit light in the first light-emitting pattern in a state where the button switch 73 is not pressed. In other words, the control unit 75 causes the tip light-emitting unit 77 to emit light in the second light-emitting pattern in a state where at least one of the tip switch 76 and the button switch 73 is in an on-state, and causes the tip light-emitting unit 77 to emit light in the first light-emitting pattern in a state where both the tip switch 76 and the button switch 73 are in an off-state.

However, a function different from that of the tip switch 76 may be allocated to the button switch 73. For example, when a user presses the button switch 73 in a case where the same function as that of the right click button of a mouse is allocated to the button switch 73, pointing of a right click is transmitted to the control unit 700 of the projector 100, and a process according to the pointing is executed. In this manner, in a case where a function different from that of the tip switch 76 is allocated to the button switch 73, the tip light-emitting unit 77 emits light in four light-emitting patterns different from each other, in accordance with the on/off-state of the tip switch 76 and the on/off-state of the button switch 73. In this case, the spontaneous emission pointing element 70 can transmit four combinations of the on/off-states of the tip switch 76 and the button switch 73 to the projector 100 while discriminating between the combinations.

Specific examples of five types of signal light depicted in FIG. 3 are summarized as follows.

(1) Projection image light IML: image light (visible light) which is projected onto the operation surface SS by the projection lens 210 in order to project the projected screen PS onto the operation surface SS.

(2) Layered detection light LL: curtain-shaped near-infrared light which is emitted over the entire projected screen PS in order to detect the pointing position of the non-emission pointing element 80.

(3) Reflection detection light RDL: near-infrared light which is reflected by the pointing elements (spontaneous emission pointing element 70 and non-emission pointing element 80) and received by the camera 310, in near-infrared light emitted as the layered detection light LL.

(4) Device signal light ASL: near-infrared light which is periodically emitted from the signal light transmitting unit 430 of the projector 100 in order to synchronize the projector 100 with the spontaneous emission pointing element 70.

(5) Pointing element signal light PSL: near-infrared light which is emitted from the tip light-emitting unit 77 of the spontaneous emission pointing element 70 at a timing synchronized with the device signal light ASL. The light-emitting pattern of the pointing element signal light PSL is changed depending on the on/off-states of the switches 73 and 76 of the spontaneous emission pointing element 70. In addition, the pattern has a specific light-emitting pattern for identifying a plurality of spontaneous emission pointing elements 70.

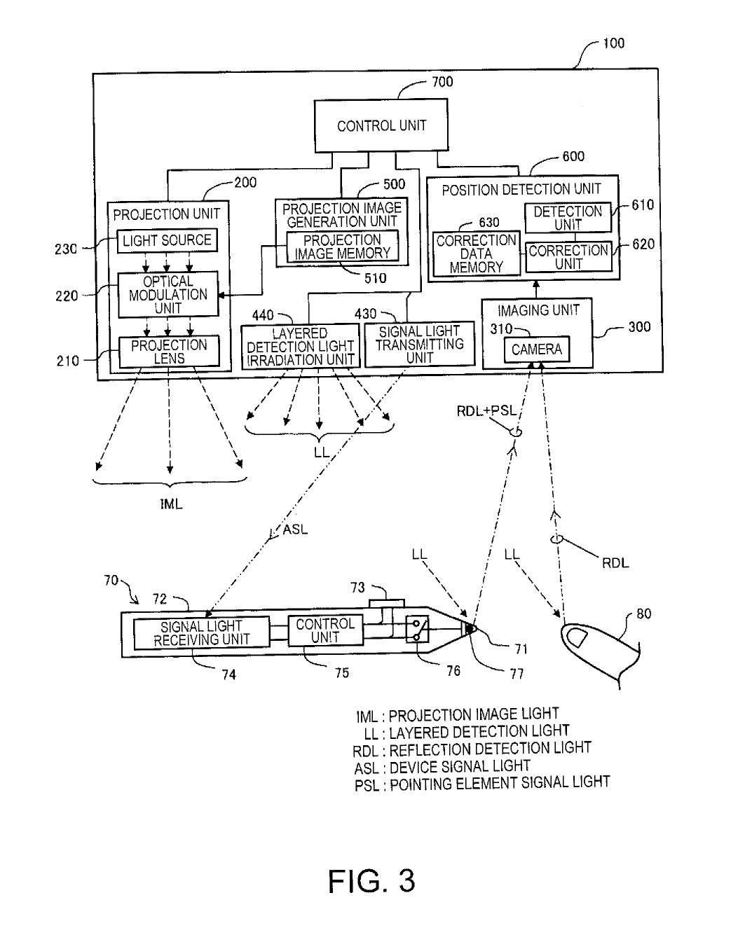

FIG. 4 is a diagram illustrating a tip offset D which is a distance between the emission position of the spontaneous emission pointing element 70 and the operation surface SS, and a detection error of a pointing position occurring due to this tip offset D. Here, a status where the tip light-emitting unit 77 is emitting light is depicted in a state where the tip of the spontaneous emission pointing element 70 is in contact on the operation surface SS. A camera position C shows the image capture reference position (for example, lens position) of the camera 310. The tip light-emitting unit 77 is a nonzero distance D (tip offset D) away from the operation surface SS. Therefore, the emission position of the tip light-emitting unit (that is, pointing position of the spontaneous emission pointing element 70) determined by analyzing the captured image captured by the camera 310 includes a detection error based on this tip offset D. Reversely, in a case where an error between the pointing position of the spontaneous emission pointing element 70 determined by analyzing the captured image and the actual pointing position thereof can be understood, it is possible to calculate a tip offset D corresponding to the error. The tip offset D calculated in this manner has a meaning as a value indicating the detection error of a pointing position rather than a physical distance between the tip light-emitting unit 77 of the spontaneous emission pointing element 70 and the operation surface SS.

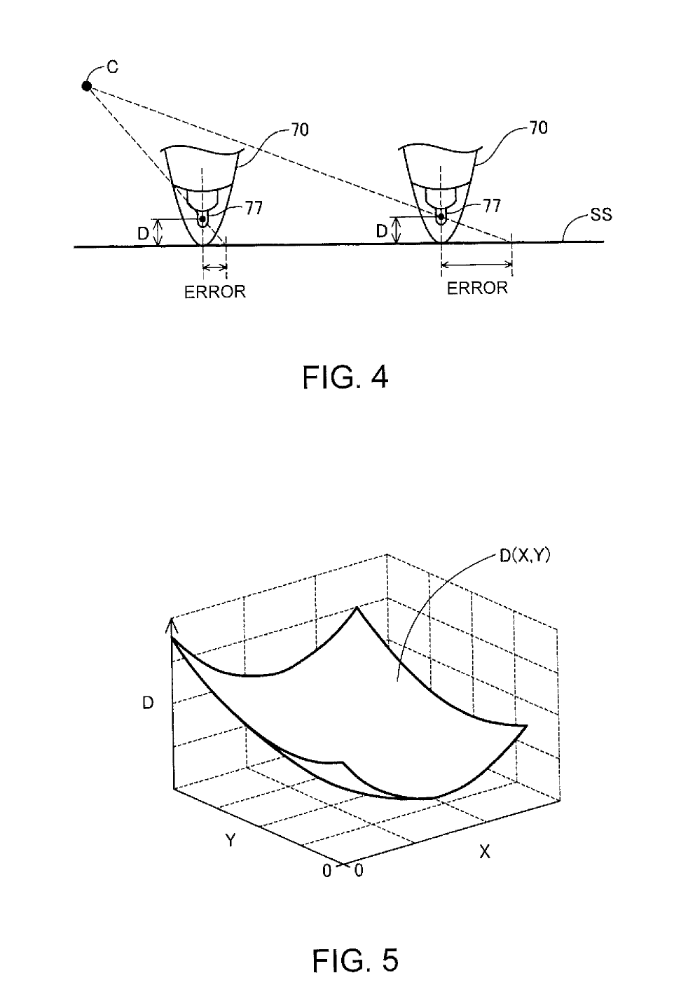

FIG. 5 shows an example of a distribution of the tip offset D calculated from the detection error of a pointing position which is actually measured in the projector 100. As shown in this drawing, it has been turned out that the tip offset D has a value varying according to the position coordinates (X, Y) of the operation surface SS rather than a constant value. In this example, the tip offset D has a distribution in the shape of a concave curved surface. In reality, the distribution of FIG. 5 is obtained by performing curved surface approximation on several pieces of actual measurement data.

The reason for the tip offset D calculated from the detection error not being a constant value is because the detection error of a pointing position detected by analyzing a captured image fluctuates due to the influence of reflected light (reflected light of light emitted by the spontaneous emission pointing element 70) on the operation surface SS, or the influence of a decrease in the size of light visible from the camera 310 with increasing distance from the camera 310. Further, the tip offset D may fluctuate due to how to hold the spontaneous emission pointing element 70, or the influence of a material of the operation surface SS.

Further, the tip offset D has a tendency to change depending on the projection distance of the projector 100. The projection distance of the projector 100 can be arbitrarily set within a certain degree of allowable range. In FIG. 2B, this projection distance is equivalent to a distance in the Z-direct ion between the operation surface SS and the projection lens 210 of the projector 100. In addition, since a distance from the camera 310 to the operation surface SS changes depending on the projection distance, the tip offset D of FIG. 5 can be represented as a function of the distance L (FIG. 2B) from the camera 310 to the operation surface SS.

Considering the above points, the tip offset D indicating the detection error of the pointing position of the spontaneous emission pointing element 70 can be represented as the following function.

D=D(X,Y,L) (1)

Here, X and Y are the coordinates on the operation surface SS, and L is a distance between the camera 310 and the operation surface SS. That is, the tip offset D is represented using a function in which the coordinates (X, Y) on the operation surface SS and the distance L from the camera 310 to the operation surface SS are used as variables.

An example of a function D (X, Y, L) to which the tip offset D is given is as follows.

$$\begin{matrix}D ( X , Y , L ) = {C}_{0} + {C}_{1} X + {C}_{2} y + {C}_{3} {X}^{2} + {C}_{4} {Y}^{2} + {C}_{5} XY & ( 2 a ) \\ {C}_{i} = ( \frac{L - {L}_{min}}{{L}_{max} - {L}_{min}} ) {C}_{imax} + ( \frac{{L}_{max} - L}{{L}_{max} - {L}_{min}} ) {C}_{imin} ( i = 0 ⋯ 5 ) & ( 2 b )\end{matrix}$$

Here, Lmax is a maximum value of the distance L between the camera 310 and the operation surface SS, Lmin is a minimum value of the distance L between the camera 310 and the operation surface SS, Cimax is a value of a coefficient Ci (i=0 to 5) in the maximum distance Lmax, and Cimin is a value of the coefficient Ci in the minimum distance Lmin.

In Expression (2a), the tip offset D is represented by a second-order expression of the coordinates X and Y on the operation surface SS. In addition, according to Expression (2b), the coefficient Ci (i=0 to 5) of each term on the right side of Expression (2a) is a value obtained by linearly interpolating the coefficient value Cimax in the maximum distance Lmax and the coefficient value Cimin in the minimum distance Lmin in accordance with the actual distance L.

The distance L between the camera 310 and the operation surface SS can be actually measured by the projector 100 itself. For example, a reference pattern image prepared in advance is projected onto the operation surface SS and is captured by the camera 310, and triangulation using the captured image and the reference pattern image within the projection image memory 510 is executed, thereby allowing the distance L to be measured. It is preferable that the position detection unit 600 (FIG. 3) has a function as such a distance measurement unit.

Instead of Expression (2a), the tip offset D can also be represented by a first-order expression or a third or higher-order expression of the coordinate values X and Y on the operation surface SS. However, in order to represent the curved surface as shown in FIG. 5, it is preferable to represent the tip offset as a function of a second or higher-order expression.

In addition, other interpolation formulae can also be used instead of Expression (2b). For example, in Expression (2b), each coefficient Ci is interpolated using two known coefficient values Cimax and Cimin corresponding to two distances Lmax and Lmin, but instead thereof, the interpolation can be performed using three or more known coefficient values corresponding to three or more distances. In a case where the interpolation is performed using three or more known coefficient values, linearly interpolation between two coefficient values adjacent to each other may be performed, or, curve interpolation between three or more known coefficient values may be performed.

Another example of the function D (X, Y, L) to which the tip offset D is given is as follows.

$$\begin{matrix}D ( X , Y , L ) = ( \frac{L - {L}_{min}}{{L}_{max} - {L}_{min}} ) {D}_{max} + ( \frac{{L}_{max} - L}{{L}_{max} - {L}_{min}} ) {D}_{min} & ( 3 a ) \\ {D}_{max} = {C}_{0 max} + {C}_{1 max} X + {C}_{2 max} y + {C}_{3 max} {X}^{2} + {C}_{4 max} {Y}^{2} + {C}_{5 max} XY & ( 3 b ) \\ {D}_{min} = {C}_{0 min} + {C}_{1 min} X + {C}_{2 min} y + {C}_{3 min} {X}^{2} + {C}_{4 min} {Y}^{2} + {C}_{5 min} XY & ( 3 c )\end{matrix}$$

Here, Lmax is a maximum value of the distance L between the camera 310 and the operation surface SS, Lmin is a minimum value of the distance L between the camera 310 and the operation surface SS, Dmax is a value of the tip offset D in the maximum distance Lmax, Dmin is a value of the tip offset D in the minimum distance Lmin, Cimax is a value of the coefficient Ci (i=0 to 5) in the maximum distance Lmax, and Cimin is a value of the coefficient Ci in the minimum distance Lmin.

Expressions (3a) to (3c) are different from Expressions (2a) and (2b), in that the tip offset D is interpolated using two known values Dmax and Dmin corresponding to two distances Lmax and Lmin. Various modifications in which Expressions (2a) and (2b) has been described can be similarly applied to Expressions (3a) to (3c).

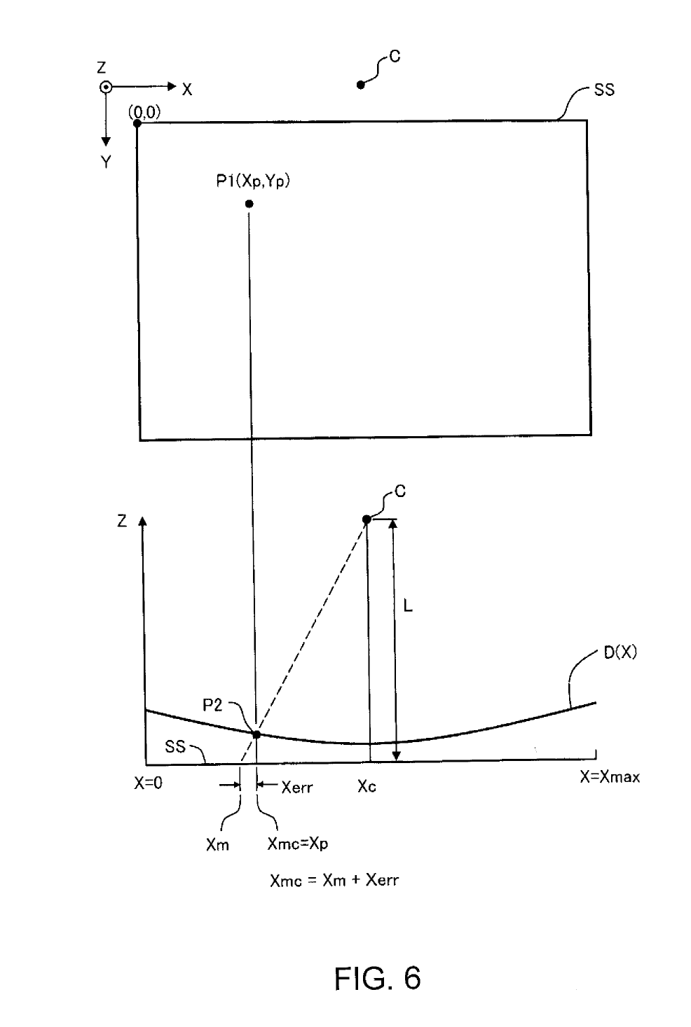

FIG. 6 is a diagram illustrating an example of a detection error of a pointing position according to the tip offset D of the spontaneous emission pointing element 70 and a correction method thereof. Here, a case is assumed in which a point P1 (Xp, Yp) on the operation surface SS is pointed by the spontaneous emission pointing element 70. The lower portion of FIG. 6 shows an example of the curved surface of the tip offset D. The detection unit 610 (FIG. 3) determines a detection position Xm by analyzing a captured image captured by the camera position C. This detection position Xm is equivalent to a position at which a straight line connecting the camera position C to a point P2 on the curved surface of the tip offset D at the point P1 (Xp, Yp) intersects the operation surface SS.

In this case, an error Xerr of the detection position Xm is represented by the following expression.

$$Xerr = \frac{D}{L} ( Xc - Xm ) \qquad ( 4 )$$

Here, D is a tip offset, L is a distance between the camera 310 and the operation surface SS, Xc is an X-coordinate value of the camera position C, and Xm is an X-coordinate value of a detection position obtained by analyzing the captured image. The distance L is known, and the tip offset D is obtained by substituting the coordinate value (Xm, Ym) of the detection position and the distance L into functions (for example, Expressions (2a) and (2b) or Expressions (3a) to (3c)) of the tip offset D. In addition, the X-coordinate value Xc of the camera position C is known.

Therefore, in a case where the detection position (Xm, Ym) is determined by the analysis of the captured image, the detection error Xerr can be calculated in accordance with Expression (4).

As shown in the following Expression (5a), the correction unit 620 (FIG. 3) corrects the detection position Xm using this detection error Xerr as a correction value, thereby allowing a detection position Xmc after correction to be obtained. Similarly, regarding a Y-coordinate value, as shown in the following Expression (5b), a detection position Ym is corrected using a detection error Yerr as a correction value, thereby allowing a detection position Ymc after correction to be obtained.

Xmc=Xm+Xerr (5a)

Ymc=Ym+Yerr (5b)

The correction data memory 630 stores correction data (correction coefficients or correction values) used for the correction of the detection position described above. For example, in a case where Expressions (2a) and (2b) or Expressions (3a) to (3c) are used, it is preferable that the correction data memory 630 stores the coefficients Cimax and Cimin and the maximum value Lmax and minimum value Lmin of the distance L. Instead thereof, the detection errors Xerr and Yerr described above may be calculated in advance, and these detection errors may be stored within the correction data memory 630 as the correction data of the detection position. In this case, it is preferable that the detection errors Xerr and Yerr are represented as a function in which the coordinate values X and Y of the operation surface SS and the distance L between the camera 310 and the operation surface SS are used as variables.

In the aforementioned description, the tip offset D and the correction values Xrr and Yerr which are used for the correction of the pointing position of the spontaneous emission pointing element 70 have been represented as a function in which the coordinate values X and Y of the operation surface SS and the distance L between the camera 310 and the operation surface SS are used as variables, but may be represented as a function in which the coordinate values X and Y of the operation surface SS are used as variables, without the distance L not being used as a variable. However, in a case where the tip offset D and the correction values Xerr and Yerr are represented as a function in which the coordinate values X and Y of the operation surface SS and the distance L are used as variables, more accurate correction can be executed.

In addition, the correction coefficients and the correction values used for the correction of the pointing position of the spontaneous emission pointing element 70 may be represented in other forms of a table, a map or the like without being required to be represented as a function. In even such cases, it is preferable that values varying according to at least a position on the operation surface SS are used as the correction values Xrr and Yerr.

As stated above, in the present embodiment, when the pointing positions Xm and Ym are corrected using the correction values Xrr and Yerr determined in accordance with the tip offset D of the spontaneous emission pointing element 70, the pointing position of the spontaneous emission pointing element 70 is corrected using a correction value varying according to the position on the operation surface SS, and thus the pointing position can be corrected using an appropriate correction value according to the position on the operation surface SS. As a result, it is possible to reduce the detection error of the pointing position occurring due to the tip offset D between the emission position of the spontaneous emission pointing element 70 and the operation surface SS.

### Modification Example

The invention is not limited to the example and the embodiment, and can be implemented in various aspects without departing from the scope of the invention. For example, the following modification can also be made.

### Modification Example 1

In the embodiment, an interactive projector has been described as an example of a position detection device, but the invention can also be applied to position detection devices other than the interactive projector. For example, the invention can also be applied to a digitizer or a tablet that points a position on an operation surface using a spontaneous emission pointing element.

As stated above, the embodiment of the invention has been described on the basis of several examples, but the embodiment of the invention is for the purpose of making the invention easier to understand, and the invention is not limited thereto. The invention can be changed and modified without departing from the gist and the appended claims, and the equivalents thereof are naturally included in the invention.

What is claimed is:

1. A position detection device that detects a pointing position pointed by a spontaneous emission pointing element on an operation surface, the device comprising:
an imaging unit that captures an image of light emitted by the spontaneous emission pointing element on the operation surface and generates a captured image;
a detection unit that detects the pointing position based on the spontaneous emission pointing element on the basis of the captured image; and
a correction unit that corrects the pointing position, using a correction value determined in accordance with a tip offset which is a distance between a contact position at which the spontaneous emission pointing element comes into contact with the operation surface and an emission position of the spontaneous emission pointing element,
wherein the correction unit corrects the pointing position using a correction value varying according to a position on the operation surface.

2. The position detection device according to claim 1, wherein the correction unit corrects the pointing position using a correction value varying according to the position on the operation surface and a distance from the imaging unit to the operation surface.

3. The position detection device according to claim 2, wherein the correction unit determines the correction value using a function in which coordinates on the operation surface and the distance from the imaging unit to the operation surface are used as variables.

4. The position detection device according to claim 3, wherein the function is a function to which the tip offset is given using the coordinates on the operation surface and the distance from the imaging unit to the operation surface as variables.

5. The position detection device according to claim 1, further comprising a projection unit that projects an image onto the operation surface.

6. A position detection system comprising:
the position detection device according to claim 1; and
the spontaneous emission pointing element.

7. A position detection system comprising:
the position detection device according to claim 2; and
the spontaneous emission pointing element.

8. A position detection system comprising:
the position detection device according to claim 3; and
the spontaneous emission pointing element.

9. A position detection system comprising:
the position detection device according to claim 4; and
the spontaneous emission pointing element.

10. A position detection system comprising:
the position detection device according to claim 5; and
the spontaneous emission pointing element.

11. A position detection method of detecting a pointing position pointed by a spontaneous emission pointing element on an operation surface, the method comprising:
(a) capturing an image of light emitted by the spontaneous emission pointing element on the operation surface and generating a captured image;
(b) detecting the pointing position based on the spontaneous emission pointing element on the basis of the captured image; and
(c) correcting the pointing position, using a correction value determined in accordance with a tip offset which is a distance between a contact position at which the spontaneous emission pointing element comes into contact with the operation surface and an emission position of the spontaneous emission pointing element,
wherein the correcting (c) includes correcting the pointing position using a correction value varying according to a position on the operation surface.
